(19) United States
(12) Patent Application Publication
(10) Pub. No.: US 2009/0063502 A1
(43) Pub. Date: Mar. 5, 2009

(54) WEB-BASED CONTENT ABSTRACTION BASED ON PLATFORM AGNOSTIC CONTAINERS ABLE TO BE EXPORTED TO PLATFORM SPECIFIC, USER CUSTOMIZABLE PORTAL PAGES

(75) Inventors: SRINIVAS J. COIMBATORE, MORRISVILLE, NC (US); AMY H. DEWAR, DURHAM, NC (US); ROBERT C. LEAH, CARY, NC (US); NICHOLAS E. POORE, DURHAM, NC (US); PETER CHI-SHING YIM, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/849,690

(22) Filed: Sep. 4, 2007

(51) Int. Cl. G06F 7/00; G06F 9/44

(52) U.S. Cl. 707/10; 719/328

(57) ABSTRACT

The present invention discloses a solution for adding user specified content to a customized portal. In the solution, URL addressable content can be selected from a user specified Web source. A platform agnostic container can be established for the content. A user selected portal platform can be determined for the established container. The container can be adjusted for the user selected platform. The adjusted container can be added to a set of user selectable objects for the platform. The user selectable objects can be customizable by a user to create a customized portal for the portal platform accessible via a URL associated with the platform. When the adjusted container is selected for a customized portal, the selected URL addressable content appears within the customized portal. The URL addressable content of the adjusted container can remain synchronized with the Web source, which ensures information currency.

### BACKGROUND

1. Field of the Invention

The present invention relates to Web-based portals, and more particularly, to Web-based content abstraction based on platform agnostic containers able to be exported to platform specific, user customizable portal pages.

2. Description of the Related Art

Users of the Internet are typically interested in content from many disparate sources. As a result, portal sites have attained great popularity due to the ability to allow users to aggregate content, often called portals, from many different sources. A portal can include many different portlets each associated with a different URI addressable content source. A vast array of new technologies has given users more control in bow they collect and consume content. These technologies have allowed users to create personalized pages, which are pages with aggregated data from many remote sources and/or portal sites.

Currently, user created portal pages rely on a catalog of customized objects specifically designed for the server which hosts the customized page. These catalogs are typically made up of content aggregating code snippets which are often called widgets or gadgets. Each widget or gadget is specific to the content it is created to aggregate and is specific to the portal server platform. For example, gadgets available for iGoogle.com conform to an iGoogle API and are unable to be used by other portal sites. Similarly, widgets available from Yahoo.com are not compatible with other portal sites. Currently, there is no industry standard for widgets, portal sites or user created portal pages.

### SUMMARY OF THE INVENTION

The present invention discloses a solution for Web-based content abstraction based on platform agnostic containers. These containers can allow a user to link to URL addressable content, such as portlets. Containers can be placed in a selectable Web catalog or other selectable data repository. A selectable Web catalog can be a platform independent catalog that includes a set of user accessible containers that can be exported to one or more specific portal platforms. Each container can be exported/software wrapped/transformed to create platform specific software objects (e.g., widgets or gadgets). The created software object can be a gadget/widget conforming to a targeted portal platform framework, which can be added to a user customized portal page. The software object can remain synchronized to the original content source so that updates are automatically presented within the software object. Thus, the containers of the solution provide a mechanism that permits a user to export/syndicate arbitrary content (e.g., the selected portlets) to any of a variety of portal frameworks without requiring a user to create custom code conforming to a portal framework API.

The present invention can be implemented in accordance with numerous aspects consistent with the material presented herein. For example, one aspect of the present invention can include a method for adding user specified content to a customized portal. The method can include a step of selecting URL addressable content from a user specified Web source. A platform agnostic container can be established for the URL addressable content. A user selected portal platform can be determined for the established container. The platform agnostic container can be adjusted for the user selected portal platform. The adjusted container can be added to a set of user selectable objects for the portal platform. The user selectable objects can be customizable by a user to create a customized portal for the portal platform accessible via a URL associated with the portal platform. When the adjusted container is selected for a customized portal, the selected URL addressable content appears within the customized portal.

Another aspect of the present invention can include a platform agnostic container for syndicating user selected Web content to a platform specific portal. The container can include a platform agnostic region within which user selected URL addressable content is placed. The container can also include one or more platform specific interfaces, each configured to permit the platform agnostic container to interact with a platform specific application program interface (API). The platform specific API (e.g., iGoogle API, NetVibes API, etc.) can be an interface for establishing user customized portals. Use of the platform agnostic container can grant an ability to add platform specific objects that contain the user selected URL addressable content without requiring an end-user to write platform specific code that conforms to a platform specific API. The software objects can remain synchronized with the content source.

Still another aspect of the present invention can include a system for permitting user selected URL addressable content to be placed in a customized platform specific portal. The system can include a content selection tool, a platform specification tool, and a portal customization tool, each of which can be accessible via a Web interface using a client remotely located from a Web server that serves pages providing the tools. The content selection tool can be used to select URL addressable content (e.g., portlets) to be placed within a platform agnostic container. The platform specification tool can be used to select a platform agnostic container that includes URL addressable content established by the content selection tool. A platform specific portal framework can be indicated for the selected platform agnostic container, where use of the platform specification tool generates a content object for the indicated platform specific portal framework. The content object can contain the URL addressable content selected via the content selection tool. The portal customization tool can be used to customizing a portal in accordance with a platform specific portal framework using a set of selectable software objects, which can be placed within a customized portal. The set of selectable software objects can include content objects generated using the platform specification tool.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for containers of user selected URL addressable content, which can generate platform specific software objects for a platform specific, user customizable portal pages in accordance with the embodiment of inventive arrangements disclosed herein.

FIG. 2 is a schematic diagram illustrating a system for selecting portlet content and placing it in widgets of a portal server via platform agnostic containers in accordance with the embodiment of inventive arrangements disclosed herein.

FIG. 3 is a graphical user interface (GUI) illustrating a system for using platform agnostic containers in accordance with the embodiments of inventive arrangements disclosed herein.

FIG. 4 is a flowchart illustrating a method for use of platform agnostic containers in accordance with the embodiments of inventive arrangements disclosed herein.

### DETAILED DESCRIPTION OF THE INVENTION

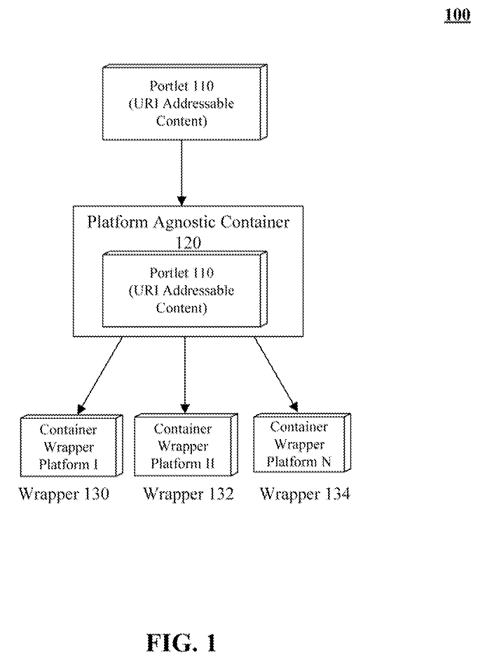

FIG. 1 is a schematic diagram illustrating a system 100 for containers of user selected URL addressable content, which can generate platform specific software objects for a platform specific, user customizable portal pages in accordance with the embodiment of inventive arrangements disclosed herein. In system 100, a URI addressable content 110 can be encapsulated/placed in a platform agnostic container 120. Platform agnostic container 120 can enabled the content 110 to be encapsulated in a platform independent manner.

Container 120 can be software wrapped in a platform specific wrapper 130-134 enabling interoperability with a target portal platform or framework. Alternatively, a set of programmatically define conversions can transform the platform agnostic container 120 into a platform specific software object 130-134. The software objects 130-134 can remain synchronized to the source of the URI addressable content 110, which ensures information currency. Programmatic instructions specific to the container 120 can ensure content synchronization.

Each of the software objects 130-134 can be treated as “widgets” or “gadgets” which a user can select and add to a customized portal page associated with the platform framework of the software object 130-134. Effectively, the containers 120 function as a layer of abstraction that permits user selected portlet content 110 to be placed in a customized portal (as a software object 130-134) in an automatically updated manner. Containers 120, therefore, permit a portlet 110 to be “syndicated” to a portal platform.

Portlet 110 can represent any selectable URI addressable content including, but not limited to, portlets, web pages, embedded content, and the like. Platform agnostic container 120 can include technologies such as AJAX, WSRP, JSR168, and the like. The software objects 130-134 can be customized for any number of portal frameworks, such as Google's portal framework, Netvibes' portal framework, Yahoo's portal framework, and the like.

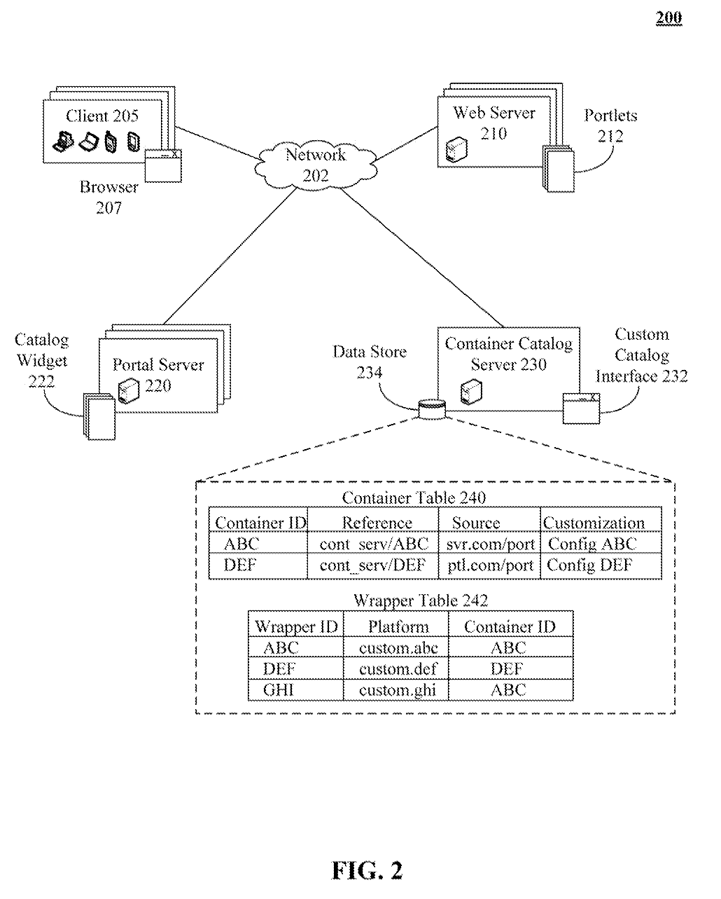

FIG. 2 is a schematic diagram illustrating a system 200 for selecting portlet 212 content and placing it in widgets 222 of a portal server 220 via platform agnostic containers in accordance with the embodiment of inventive arrangements disclosed herein.

In system 200, a container catalog server 230 can allow portlets 212 on web server 210 to be interoperable with external portal sites 220. Container catalog server 230 can present a user with custom catalog interface 232 which can allow a user to add any portlet 212 content to a platform specific portal server 220.

Container catalog server 230 can provide a platform agnostic container and platform specific wrapper for portlets 212. Container and wrapper configuration can be directed by data stored in data store 234. Customization of container can be performed through custom catalog interface 232. Container table 240 can store container ID, source content, customization settings, and the like. Specific wrapper level settings can be stored in a wrapper table 242. Wrapper table 242 can denote wrapper ID, platform targeted by wrapper, container associated with wrapper, and the like.

Client 205 utilizing Web browser 207 can include a plug-in for interacting with custom catalog interface 232. In one embodiment, custom catalog interface 232 can be a searchable compilation presented to a user in a desktop application.

To illustrate components of system 200, browser 207 can include a container plug-in, which permits a user to present portlet 212 content and to send a reference to the portlet 212 to server 230. This causes a new entry of table 240 to be established for a new container (e.g. Container ABC). This entry can include a reference link (e.g., http://cont_serv.com/ABC) and can include a reference to the source (e.g., http://svr.com/port). Other portlets 212 can be browsed 207 and targeted for the server 230, which results in additional table 240 entries (e.g. Container DEF). Client 205 can then access the server via interface 232.

The interface 232 can present the user with the user created containers as well as other containers that the user is authorized to access. In one embodiment, users can be permitted to share their containers with other users and a set of common use containers can also be established by server 230. A user can choose to customize a container, which adds a customization entry to table 240. Using interface 232, the user of client 205 can select a target portal platform. Upon selection, a new software object (e.g., catalog widget 222) for the target portal platform can be generated. Each container can be used to generate multiple software objects for different portal platforms. Each software object can be associated with an entry in table 242. That is, a wrapper (e.g., ABC) for platform (e.g., custom.abc) can be associated with a container (Container ABC). In a different implementation (that transforms instead of wraps containers), the table 242 can indicate transformation programs to be executed to convert a particular container into a software object conforming to a target portal platform.

After software objects (widget 222) has been created from a container, client 205 can access a widget catalog 222 of portal server 220, which now includes container generated objects. The widget catalog 222 can be an optional component available on some, but not all, portal platforms. When no widget catalog 222 exists for a target platform, the software object created from the container can be placed in a user-accessible data store (e.g., a data store of client 205, a data store of server 220, etc.). The client 205 can add the container objects and other widgets 222 to create a custom portal page. When a custom portal is presented in browser 207 that includes a server 230 generate software object, the object can remain synchronized with the portlet 212 source to ensure information currency.

As shown herein, data store 234 can be physically implemented within any type of hardware including, but not limited to, a magnetic disk, an optical disk, a semiconductor memory, a digitally encoded plastic memory, a holographic memory, or any other recording medium. The data store 234 can be stand-alone storage units as well as a storage unit formed from a plurality of physical devices, which may be remotely located from one another. Additionally, information can be stored within the data store 234 in a variety of manners. For example, information, such as tables 240, 242, can be stored within a database structure or can be stored within one or more files of a file storage system, where each file may or may not be indexed for information searching purposes.

The network 202 can include components capable of conveying digital content encoded within carrier waves. The content can be contained within analog or digital signals and conveyed through data or voice channels and can be conveyed over a personal area network (PAN) or a wide area network (WAN). The network 202 can include local components and data pathways necessary for communications to be exchanged among computing device components and between integrated device components and peripheral devices. The network 202 can also include network equipment, such as routers, data lines, hubs, and intermediary servers which together form a packet-based network, such as the Internet or an intranet. The network 202 can further include circuit-based communication components and mobile communication components, such as telephony switches, modems, cellular communication towers, and the like. The network 202 can include line based and/or wireless communication pathways.

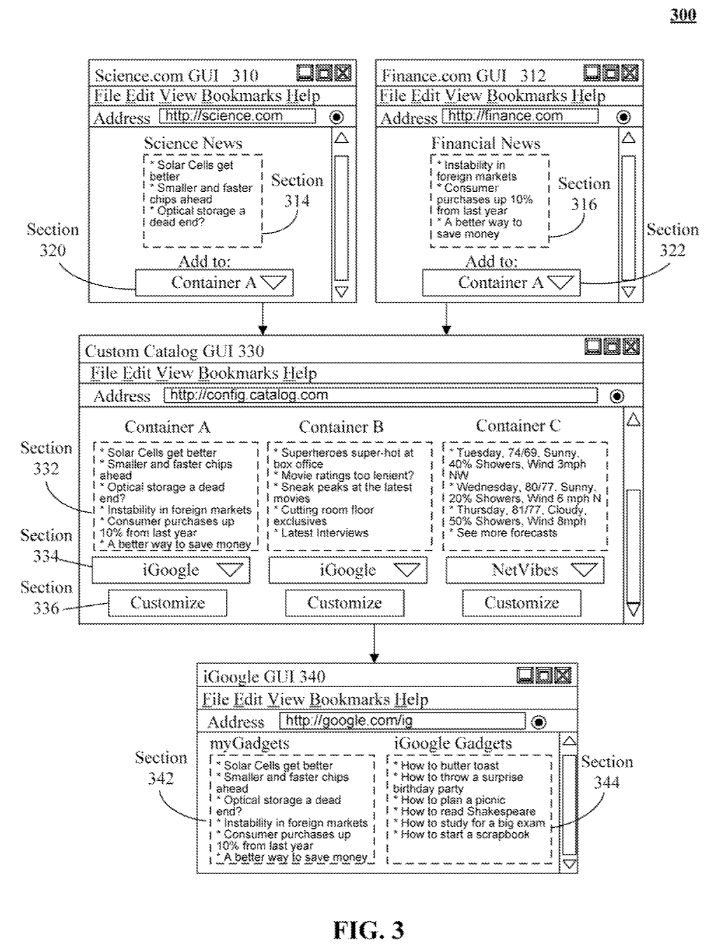

FIG. 3 is a graphical user interface (GUI) illustrating a system 300 for using platform agnostic containers in accordance with the embodiments of inventive arrangements disclosed herein. GUIs of system 300 can be interfaces of system 200.

In system 300, a user can access a science Web page shown in GUI 310. This Web page can include a section 314 of URL addressable content. An export control 320 can permit the section 314 to be exported to a user selectable container (e.g., Container A). The user can also access a finance Web page as shown in GUI 312. GUI 312 can include a new portlet section 316, which a user can select and export to Container A, using control 322. The controls 320, 322 can be coded specifically for the Web sites, can be browser controls, and/or can be associated with a browser plug-in designed to export content to containers when enabled. In another embodiment, (not shown) a container specific Web page can include the controls 320, 322 and can include an interior browsing frame section, which enables a user to navigate to desired content and subsequently select portions of that content (314, 316).

After sending content to containers, a user can access a custom catalog GUI 330. GUI 330 can include containers for all user available content, options to convert a container to a target portal platform 334, and options to customize 336 the containers. Containers need not be identical to an original source, as shown by section 332, which combines content from section 314 and section 316.

After one or more containers have been transformed for a target platform, a user can access an interface 340 for that platform. The container created software object 342 will be selectable along with other software objects 344 specifically designed for the portal platform.

It should be appreciated that the graphical user interface (GUI), GUI elements, and graphical artifacts presented herein are for illustrative purposes only and are not meant to limit the invention in any regard.

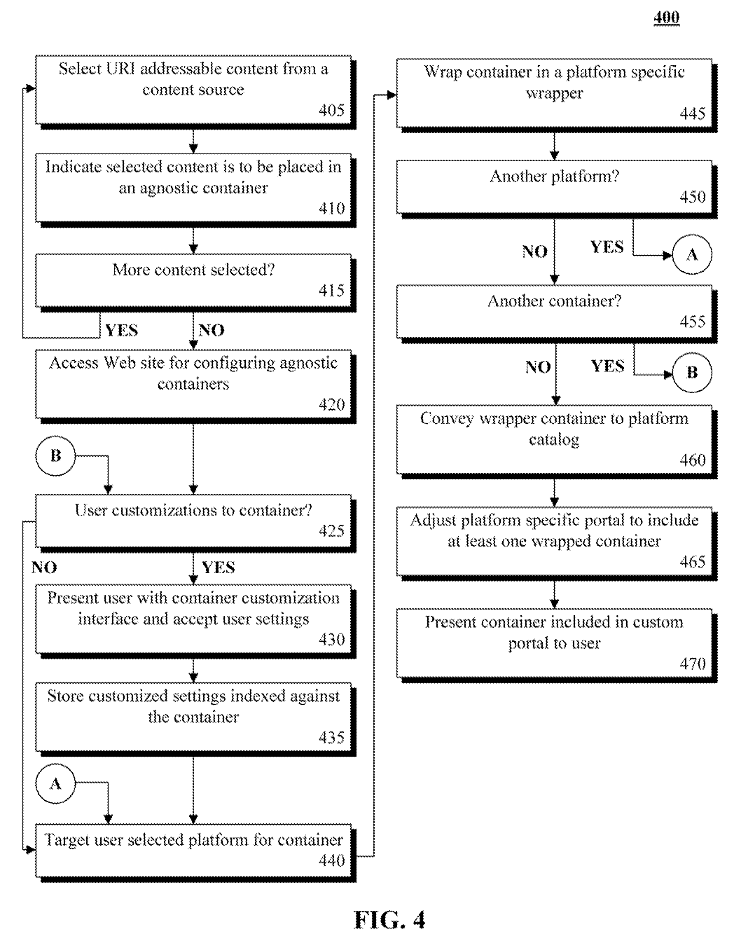

FIG. 4 is a flowchart illustrating a method 400 for use of platform agnostic containers in accordance with the embodiments of inventive arrangements disclosed herein. Method 400 can be performed in the context of system 200. In method 400, a user can select URI addressable content to be exported to a target portal site.

The method can begin in step 405, where URI addressable content (e.g., portlet content) can be selected from a content source. In step 410, a user can indicate that the selected content is to be placed in an agnostic container. In determining step 415, if more content is selected the method can return to step 405, else the method can proceed to step 420. In step 420, the user can access a Web site for configuring agnostic containers. In determining step 425, if the user has customizations to the container, the method can proceed to step 430, else the method can proceed to step 440. In step 430, the user can be presented with a container customization interface within which user settings established and finalized. User customized settings can be stored and indexed against the container as shown in step 435. In step 440, the user can select a target platform for container. In step 445, the container can be wrapped in a platform specific wrapper to make it interoperable with target platform. In a different embodiment, the container can be converted into a platform specific software object.

In determining step 450, if the user selects another platform the method can proceed to step 440, else the method can proceed to step 455. In second determining step 455, if the user selects another container the method can return to step 425, else the method can proceed to step 460. In step 460, the wrapper container can be conveyed to a platform catalog. In step 465, a platform specific portal can be adjusted to include at least one wrapper container. For example, in step 465, a wrapped container can be selected and added to a customized portal. The method can end in step 470 wherein the user can be presented with the container in a custom portal. Content of the container can remain synchronized with the original source and can be updated accordingly.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method for adding user specified content to a customized portal comprising:
selecting URL addressable content from a user specified Web source;
establishing a platform agnostic container for the URL addressable content;
determining a user selected portal platform for the established container;
adjusting the platform agnostic container for the user selected portal platform; and
adding the adjusted container to a set of user selectable objects for the portal platform, wherein the user selectable objects are customizable by a user to create a customized portal for the portal platform accessible via a URL associated with the portal platform, wherein when the adjusted container is selected for a customized portal, the selected URL addressable content appears within the customized portal.

2. The method of claim 1, wherein the URL addressable content of the adjusted container remains synchronized with the Web source, which ensures information currency.

3. The method of claim 1, wherein the URL addressable content comprises a portlet.

4. The method of claim 1, wherein in absence of the adjusted container, none of the user selected objects specific to the portal platform include the selected URL addressable content.

5. The method of claim 1, further comprising:
processing the platform agnostic container for a different user selected portal platform; and
adding the processed container to a set of user selectable objects for the different portal platform, wherein the user selectable objects are customizable by a user to create a different customized portal for the different portal platform accessible via a URL associated with the different portal platform, wherein when the processed container is selected for a different customized portal, the selected URL addressable content appears within the different customized portal.

6. The method of claim 1, wherein the portal platform is associated with a portal platform application program interface (API) to which the user selectable objects conform.

7. The method of claim 6, wherein the adjusting step utilizes a set of programmatically defined conversion instructions to programmatically convert the platform agnostic container that does not conform to the portal platform application program interface (API) into one of the user selectable objects that does confirm to the portal platform application program interface (API).

8. The method of claim 6, wherein the adjusting step wraps the platform agnostic container in a software wrapper, wherein said software wrapper interfaces with the platform agnostic container that does not conform to the portal platform application program interface (API), and wherein once software wrapped, the adjusted container conforms to the portal platform application program interface (API).

9. The method of claim 1, further comprising:
presenting within a client browser a Web page that shows the established container along with a plurality of options for configuring the established container, wherein one of the options is for targeting a user selectable portal platform, wherein the Web page is served by a Web server independent of said user selected portal platform, wherein said user selected portal platform is selected via a user interaction with the Web page.

10. The method of claim 1, further comprising:
presenting within a client browser a portal customization Web page associated with the user selected portal platform, said portal customization Web page comprising a plurality of portal platform specific objects and said adjusted platform agnostic container.

11. The method of claim 1, wherein said steps of claim 1 are steps performed automatically by at least one machine in accordance with at least one computer program having a plurality of code sections that are executable by the at least one machine, said at least one computer program being stored in a machine readable medium.

12. A platform agnostic container for syndicating user selected Web content to a platform specific portal comprising;
a platform agnostic region within which user selected URL addressable content is placed; and
a plurality of platform specific interfaces each configured to permit the platform agnostic container to interact with a platform specific application program interface (API), where said platform specific application program interface (API) is an interface for establishing user customized portals, wherein use of the platform agnostic container grants an ability to add platform specific objects that contain said user selected URL addressable content without requiring an end-user to write platform specific code that conforms to a platform specific application program interface (API), wherein the platform specific objects remain synchronized with a source of the URL addressable content.

13. The container of claim 12, wherein the platform agnostic container is one of many such containers, which are able to be presented in a Web catalog of containers, which are able to be exported in a platform specific format so that a user is able to use an exported platform specific container that comprises user selected URL addressable content to within a customized portal comprising multiple platform specific objects, which include said exported platform specific container.

14. The container of claim 12, wherein the URL addressable content comprises a portlet.

15. The container of claim 12, further comprising:
a plurality of platform specific software wrappers for the platform agnostic container one for each of the platform specific interfaces, wherein said platform specific software wrapper is configured to interface with the platform agnostic container and is also configured to interface with a platform specific application program interface (API).

16. The container of claim 12, wherein each of said platform specific interfaces comprises a set of conversion instructions for programmatically transforming a platform agnostic container into a software object that conforms to a platform specific application program interface (API).

17. A system for permitting user selected URL addressable content to be placed in a customized platform specific portal comprising;
a content selection tool accessible via a Web interface from a remotely located client for selecting URL addressable content to be placed within a platform agnostic container;
a platform specification tool accessible via a Web interface from the remotely located client for selecting a platform agnostic container comprising URL addressable content established by the content selection tool, wherein a platform specific portal framework is indicated for the a selected platform agnostic container, wherein use of the platform specification tool generates a content object for the indicated platform specific portal framework, said content object containing the URL addressable content selected via the content selection tool;
a portal customization tool accessible via a Web interface from the remotely located client for customizing a portal in accordance with a platform specific portal framework using a set of selectable software objects, which can be placed within a customized portal, wherein said set of selectable software objects comprise content objects generated using the platform specification tool, wherein the content objects remain synchronized with a source of the URL addressable content.

18. The system of claim 17, further comprising:
a container configuration tool accessible via a Web interface from the remotely located client configured to permit a user to customize the platform agnostic container.

19. The platform agnostic container of claim 17, further comprising:
a platform agnostic container catalog, which is a Web catalog comprising a user specific set of platform agnostic containers comprising content selected by the user via the content selection tool, wherein said platform agnostic container catalog comprises the platform specification tool that is able to be used with any of the platform agnostic containers in the platform agnostic container catalog.

20. The system of claim 17, wherein the URL addressable content comprise portlets, wherein the platform specification tool and the portal customization tool are contained within separate Web sites maintained by different entities, wherein the Web site containing the platform specification tool is independent of any platform specific portal framework.
